(19) United States
(12) Patent Application Publication
(10) Pub. No.: US 2024/0319575 A1
(43) Pub. Date: Sep. 26, 2024

(54) PROJECTOR

(71) Applicant: SEIKO EPSON CORPORATION, Tokyo (JP)

(72) Inventor: Koichi AKIYAMA, Azumino-shi (JP)

(21) Appl. No.: 18/621,186

(22) Filed: Mar. 29, 2024

(30) Foreign Application Priority Data
Mar. 31, 2023 (JP) 2023-057586

(51) Int. Cl. G03B 21/20

(52) U.S. Cl. CPC G03B 21/208; G03B 21/2053; G03B 21/2073

(57) ABSTRACT

A projector includes a light source, a collimator collimating a first light emitted from the light source, a first multi-lens array having a plurality of first small lenses dividing the first light into a plurality of partial pencils of light, and a plurality of light incident regions each containing at least two of the first small lenses, a second multi-lens array having a plurality of second small lenses placed to correspond to the respective plurality of light incident regions, a superimposing lens superimposing the plurality of partial pencils of light emitted from the respective plurality of second small lenses on an illumination area, and a light modulator containing an image formation area as the illumination area and modulating light. The partial pencils of light emitted from at least the two respective first small lenses contained in the corresponding single light incident region enter the single second small lens.

The present application is based on, and claims priority from JP Application Serial Number 2023-057586, filed Mar. 31, 2023, the disclosure of which is hereby incorporated by reference herein in its entirety.

### BACKGROUND

### 1. Technical Field

The present disclosure relates to a projector.

### 2. Related Art

In related art, in a projector, there is a technique of entering respective lights output from a plurality of small lenses of a first lens array into a single small lens of a second lens array and divisionally illuminating an image formation area of a liquid crystal panel via a condenser lens (for example, see JP-A-2015-145943.)

In the projector, to suppress illuminance irregularities due to overlap of an outer edge portion of an illumination light in a relatively small amount of light with the image formation area within a plane perpendicular to the principal ray of the illumination light, the image formation area of the liquid crystal panel is irradiated with an inner area than the outer edge portion of the illumination light. Accordingly, the outer edge portion of the illumination light is hard to be used as an image light and that causes reduction of light use efficiency of the illumination light.

### SUMMARY

In order to solve the above described problem, according to an aspect of the present disclosure, a projector including a light source, a collimator configured to collimate a first light emitted from the light source, a first multi-lens array having a plurality of first small lenses configured to divide the first light collimated by the collimator into a plurality of partial pencils of light, and a plurality of light incident regions each containing at least two of the first small lenses, a second multi-lens array having a plurality of second small lenses placed to correspond to the respective plurality of light incident regions of the first multi-lens array, a superimposing lens configured to superimpose the plurality of partial pencils of light emitted from the respective plurality of second small lenses of the second multi-lens array on an illumination area, and a light modulator containing an image formation area as the illumination area and configured to modulate light emitted from the superimposing lens. The partial pencils of light emitted from the respective at least two first small lenses contained in the corresponding single light incident region enter the single second small lens.

### BRIEF DESCRIPTION OF THE DRAWINGS

FIG. 1 is a schematic configuration diagram showing a projector of a first embodiment.

FIG. 2 shows a schematic configuration of an illumination device.

FIG. 3 shows a correspondence relationship between first small lenses and second small lenses.

FIG. 4 is an explanatory diagram of functions of first, second multi-lens arrays and a superimposing lens.

FIG. 5A shows a simulation result of the present disclosure.

FIG. 5B shows a simulation result of the present disclosure.

FIG. 5C shows a simulation result of the present disclosure.

FIG. 5D shows a simulation result of the present disclosure.

FIG. 6 is a schematic configuration diagram showing a projector of a second embodiment.

FIG. 7 shows a configuration of a main part of a projector of a modified example.

FIG. 8A shows an example of a different correspondence relationship between first small lenses and a second small lens.

FIG. 8B shows an example of a different correspondence relationship between first small lenses and a second small lens.

### DESCRIPTION OF EMBODIMENTS

As below, one embodiment of the present disclosure will be explained in detail with reference to the drawings. Note that, in the drawings used in the following explanation, to clearly show characteristics, for convenience, the characteristic parts may be enlarged and the dimensional ratios of the respective component elements are not necessarily the same as the real dimensional ratios.

### First Embodiment

As below, a projector of a first embodiment of the present disclosure will be explained.

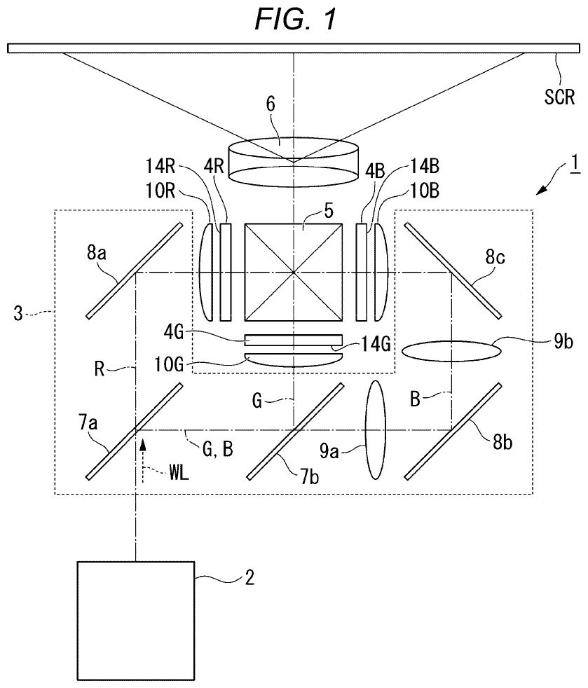

FIG. 1 is a schematic configuration diagram showing the projector of the first embodiment.

As shown in FIG. 1, a projector 1 of the embodiment is a projection-type image display apparatus displaying pictures on a screen SCR. The projector 1 includes an illumination device 2, a color separation system 3, a light modulator 4R, a light modulator 4G, a light modulator 4B, a light combining system 5, and a projection optical device 6.

The illumination device 2 outputs a white illumination light WL toward the color separation system 3. The configuration of the illumination device 2 will be specifically described later.

The color separation system 3 separates the illumination light WL into a red illumination light R, a green illumination light G, and a blue illumination light B. The color separation system 3 includes a dichroic mirror 7a and a dichroic mirror 7b, a total reflection mirror 8a, a total reflection mirror 8b, and a total reflection mirror 8c, and a first relay lens 9a and a second relay lens 9b. Hereinafter, red, green, and blue may be collectively referred to as “RGB respective colors”.

The dichroic mirror 7a separates the illumination light WL from the illumination device 2 into the red illumination light R and the other lights (the green illumination light G and the blue illumination light B). The dichroic mirror 7a transmits the red illumination light R and reflects the other lights. The dichroic mirror 7b reflects the green illumination light G and transmits the blue illumination light B.

The total reflection mirror 8a reflects the red illumination light R toward the light modulator 4R. The total reflection mirror 8b and the total reflection mirror 8c guide the blue illumination light B to the light modulator 4B. The green illumination light G is reflected from the dichroic mirror 7b toward the light modulator 4G.

The first relay lens 9a and the second relay lens 9b are placed downstream of the dichroic mirror 7b in the optical path of the blue illumination light B.

The light modulator 4R has an image formation area 14R modulating the red illumination light R according to image information and forming a red image light. The light modulator 4G has an image formation area 14G modulating the green illumination light G according to image information and forming a green image light. The light modulator 4B has an image formation area 14B modulating the blue illumination light B according to image information and forming a blue image light.

For the light modulator 4R, the light modulator 4G, and the light modulator 4B, e.g., transmissive liquid crystal panels are used. Further, polarizers (not shown) are placed at respective light incident sides and light exiting sides of the liquid crystal panels.

At light incident sides of the light modulator 4R, the light modulator 4G, and the light modulator 4B, a field lens 10R, a field lens 10G, and a field lens 10B are placed, respectively.

The respective image lights from the light modulator 4R, the light modulator 4G, and the light modulator 4B enter the light combining system 5. The light combining system 5 combines the respective image lights and outputs the combined image light toward the projection optical device 6. For the light combining system 5, e.g., a cross dichroic prism is used.

The projection optical device 6 includes a projection lens group and enlarges and projects the image light combined by the light combining system 5 toward the screen SCR. Thereby, an enlarged color picture is displayed on the screen SCR.

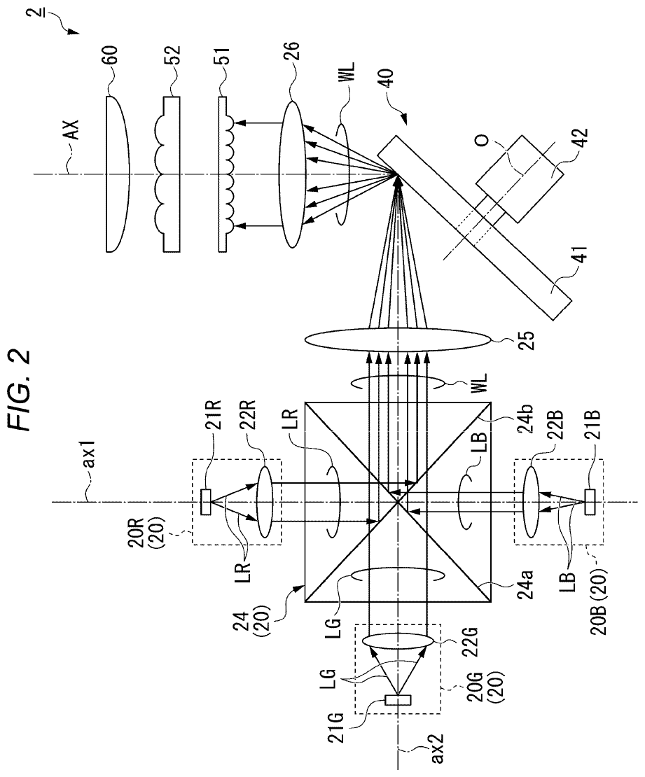

FIG. 2 shows a schematic configuration of the illumination device 2.

As shown in FIG. 2, the illumination device 2 includes a light source 20, a collecting lens 25, a rotary diffuser 40, a collimator 26, a first multi-lens array 51, a second multi-lens array 52, a superimposing lens (superimposing element) 60, and an adjustment mechanism 30.

The light source 20 includes a red light source unit 20R, a green light source unit 20G, a blue light source unit 20B, and a light combining system 24.

In the embodiment, the red light source unit 20R, the light combining system 24, and the blue light source unit 20B are provided on an optical axis ax1 of the red light source unit 20R. The green light source unit 20G, the light combining system 24, and the rotary diffuser 40 are provided on an optical axis ax2 of the green light source unit 20G. The optical axis ax1 and the optical axis ax2 are orthogonal to each other. Note that an optical axis of the blue light source unit 20B is aligned with the optical axis ax1 of the red light source unit 20R.

Further, the rotary diffuser 40, the collimator 26, the first multi-lens array 51, the second multi-lens array 52, and the superimposing lens 60 are provided on an illumination optical axis AX of the illumination device 2. The illumination optical axis AX and the optical axis ax1 are parallel to each other.

The red light source unit 20R has a red light emitter 21R and a collimator lens 22R. The green light source unit 20G has a green light emitter 21G and a collimator lens 22G. The blue light source unit 20B has a blue light emitter 21B and a collimator lens 22B. In the embodiment, the light source 20 has the red light emitter 21R, the green light emitter 21G, and the blue light emitter 21B as light sources outputting lights.

The red light emitter 21R outputs a red light LR as a laser beam having e.g., a wavelength range from 585 nm to 720 nm. The collimator lens 22R converts the red light LR output from the red light emitter 21R into a parallel light.

The green light emitter 21G outputs a green light LG as a laser beam having e.g., a wavelength range from 495 nm to 585 nm. The collimator lens 22G converts the green light LG output from the green light emitter 21G into a parallel light.

The blue light emitter 21B outputs a blue light LB as a laser beam having e.g., a wavelength range from 380 nm to 495 nm. The collimator lens 22B converts the blue light LB output from the blue light emitter 21B into a parallel light.

Note that, in FIG. 2, as each of the light source units 20R, 20G, 20B, a single laser beam source and a single collimator lens are shown, however, the numbers and the placements of the laser beam sources and the collimator lenses are not limited. Further, each of the light source units 20R, 20G, 20B may have another member such as a package holding the laser beam source and the collimator lens.

The light combining system 24 includes a cross dichroic prism. The cross dichroic prism has a first dichroic mirror 24a and a second dichroic mirror 24b. The first dichroic mirror 24a and the second dichroic mirror 24b are respectively placed to cross the optical axis ax1 and the optical axis ax2 at 45°. Further, the first dichroic mirror 24a and the second dichroic mirror 24b cross each other to form angles of 45°.

The first dichroic mirror 24a has an optical property of reflecting the blue light LB and transmitting the green light LG and the red light LR. The second dichroic mirror 24b has an optical property of reflecting the red light LR and transmitting the blue light LB and the green light LG.

The collecting lens 25 collects and enters the illumination light WL into the rotary diffuser 40. The rotary diffuser 40 is placed at the light exiting side of the collecting lens 25. The rotary diffuser 40 has a diffuser plate 41 rotatable around a predetermined rotation axis O and a driver 42 as a motor. For example, the diffuser plate 41 is configured with formation of a concavo-convex structure on a surface of a metal circular plate of aluminum or the like by e.g., an etching process, a blast process, or the like. The rotary diffuser 40 is placed to cross the optical axis ax2 and the illumination optical axis AX at 45°. The rotary diffuser 40 is placed near a collection position or a focal position of the collecting lens 25. The rotary diffuser 40 suppresses generation of speckles that lower display quality by diffusing the illumination light WL.

The collimator 26 includes a collimator lens. The collimator 26 parallelizes the illumination light (first light) WL output from the light source 20 and diffused by the rotary diffuser 40 and outputs the light toward the first multi-lens array 51. In the case of the embodiment, the collimator 26 includes a single convex lens. Note that the collimator 26 may include a plurality of lenses.

The first multi-lens array 51 has a plurality of first small lenses 53 dividing the illumination light WL output from the collimator 26 into a plurality of partial pencils of light. The plurality of first small lenses 53 are arranged in a matrix form within a plane orthogonal to the illumination optical axis AX.

The second multi-lens array 52 has a plurality of second small lenses 54 entered by the plurality of partial pencils of light entering from the respective corresponding first small lenses 53 as will be described later.

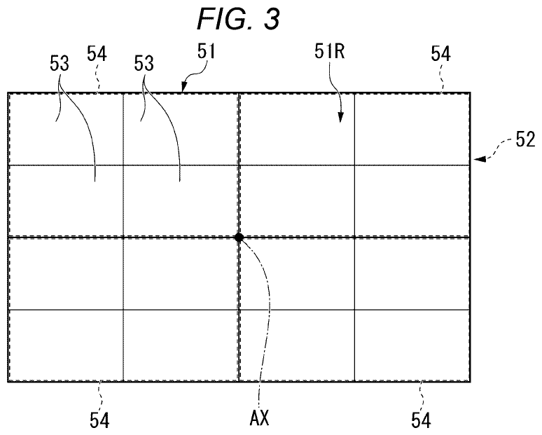

FIG. 3 shows a correspondence relationship between the first small lenses 53 and the second small lenses 54. FIG. 3 is a plan view of the first multi-lens array 51 and the second multi-lens array 52 as seen from a light incident surface side of the first multi-lens array 51.

As shown in FIG. 3, the first multi-lens array 51 has a plurality of light incident regions 51R within a plane orthogonal to the illumination optical axis AX. Specifically, in the first multi-lens array 51, the plurality of light incident regions 51R are arranged in an array form of two rows and two columns. In each light incident region 51R of the first multi-lens array 51, the first small lenses 53 are arranged in an array form of two rows and two columns. That is, the four first small lenses 53 are placed in the single light incident region 51R of the first multi-lens array 51. The respective first small lenses 53 of the first multi-lens array 51 have the same size and curvature.

The second multi-lens array 52 has the plurality of second small lenses 54 within the plane orthogonal to the illumination optical axis AX. It is desirable that each of the plurality of second small lenses 54 is formed using an aspheric lens.

Each of the plurality of second small lenses 54 is provided to correspond to each light incident region 51R of the first multi-lens array 51. That is, the single second small lens 54 corresponds to the single light incident region 51R in the first multi-lens array 51. Accordingly, in the second multi-lens array 52 of the embodiment, the partial pencils of light output from the respective four first small lenses 53 enter each second small lens 54. That is, the partial pencils of light output from the respective four first small lenses 53 contained in the single light incident region 51R corresponding to the single second small lens 54 enter the single second small lens 54. The respective second small lenses 54 of the second multi-lens array 52 have the same size and curvature.

The planar shape of the light incident region 51R of the first multi-lens array 51 as seen in a direction along the illumination optical axis AX is a rectangular shape similar to the planar shapes of the respective image formation areas 14R, 14G, 14B of the light modulators 4R, 4G, 4B. Here, the planar shape of the light incident region 51R refers to a shape defined by lines connecting the outermost shapes of the four first small lenses 53 placed in the light incident region 51R. That is, in other words, the aspect ratio of the light incident region 51R is equal to the aspect ratios of the respective image formation areas 14R, 14G, 14B of the light modulators 4R, 4G, 4B.

Further, the aspect ratios of the respective four first small lenses 53 of the light incident region 51R are equal to the aspect ratios of the respective image formation areas 14R, 14G, 14B of the light modulators 4R, 4G, 4B. According to the configuration, the aspect ratio of the first multi-lens array 51 is made equal to the aspect ratios of the light modulators 4R, 4G, 4B, and thereby, the first multi-lens array 51 is easily manufactured.

Note that, as will be described later, the aspect ratios of the respective plurality of partial pencils of light illuminating the respective image formation areas 14R, 14G, 14B are equal.

Note that the number and the placement of the first small lenses 53 in each light incident region 51R of the first multi-lens array 51 is not limited to the above described configuration. Each light incident region 51R of the first multi-lens array 51 may contain at least two first small lenses 53. That is, the single light incident region 51R may contain at least two first small lenses 53. Further, the second multi-lens array 52 has the same number of second small lenses 54 as the corresponding light incident regions 51R.

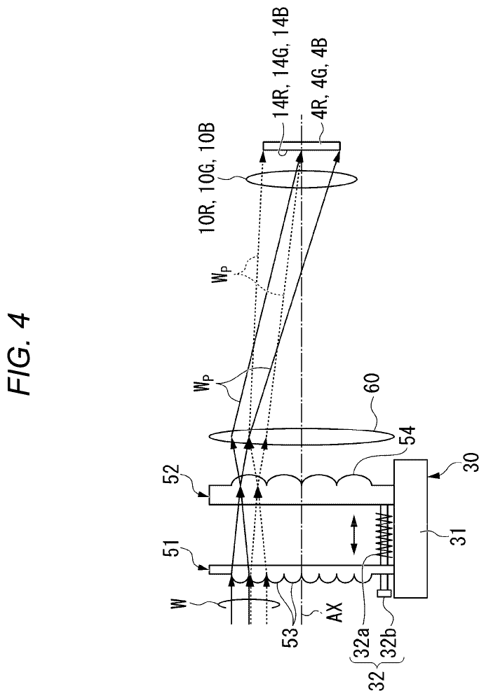

FIG. 4 is a diagram for explanation of functions of the first multi-lens array 51, the second multi-lens array 52, and the superimposing lens 60. The illumination light WL is separated into the red illumination light R, the green illumination light G, and the blue illumination light B by the color separation system 3 and respectively illuminates the light modulators 4R, 4G, 4B, and all behaviors of the respective illumination lights R, G, B are equal and the same applies to the illumination lights.

Accordingly, in the following description, the lights entering the image formation areas 14R, 14G, 14B of the light modulators 4R, 4G, 4B via the first multi-lens array 51, the second multi-lens array 52, and the superimposing lens 60 are referred to as “illumination light W” without distinction and the pencils of light obtained by division of the illumination light W into the plurality of pieces by the first multi-lens array 51 are referred to as “partial pencils of light Wp”.

As shown in FIG. 4, each first small lens 53 of the light incident region 51R divides the illumination light W into a plurality of partial pencils of light Wp. The partial pencils of light Wp divided by each first small lens 53 enter different positions of the second small lens 54 corresponding to the light incident region 51R. The respective partial pencils of light Wp are collected to near a light exiting surface of the second small lens 54.

The second small lenses 54 form images of the partial pencils of light Wp of the first small lenses 53 on the image formation areas 14R, 14G, 14B of the light modulators 4R, 4G, 4B with the superimposing lens 60. As shown in FIG. 4, the images of the first small lenses 53 adjacent in the light incident regions 51R are formed in the different positions of the respective image formation areas 14R, 14G, 14B. That is, the image formation areas 14R, 14G, 14B are illuminated by the divided four partial pencils of light Wp.

The superimposing lens 60 superimposes the plurality of partial pencils of light Wp output from the respective second small lenses 54 of the second multi-lens array 52 on the respective image formation areas 14R, 14G, 14B. In this manner, the illumination device 2 of the embodiment illuminates the image formation areas 14R, 14G, 14B of the light modulators 4R, 4G, 4B by superimposing the partial pencils of light Wp divided by the respective first small lenses 53 of the plurality of light incident regions 51R of the first multi-lens array 51.

The adjustment mechanism 30 adjusts the distance between the first multi-lens array 51 and the second multi-lens array 52. The adjustment mechanism 30 adjusts the relative position of the first multi-lens array 51 and the second multi-lens array 52 in the direction along the illumination optical axis AX.

The adjustment mechanism 30 has a base portion 31 holding the first multi-lens array 51 and the second multi-lens array 52, and a drive unit 32 provided in the base portion 31 and enabling the first multi-lens array 51 and the second multi-lens array 52 to move along the directions along the illumination optical axis AX. The drive unit 32 has a spring member 32a provided between the first multi-lens array 51 and the second multi-lens array 52 and a ball spring 32b pressing the first multi-lens array 51 and the second multi-lens array 52 via the spring member 32a.

As below, in the projector 1 of the embodiment, the behavior of the illumination light W entering the image formation areas 14R, 14G, 14B of the light modulators 4R, 4G, 4B will be explained.

First, as a comparative example, for example, like the above described JP-A-2015-145943, a configuration in which a first small lens of a first multi-lens array correspond to a second small lens of a second multi-lens array correspond on a one-on-one basis will be explained.

In the case of the configuration of the comparative example, partial pencils of light divided by the respective first small lenses of the first multi-lens array are superimposed on the image formation areas of the light modulators via the corresponding second small lenses and the superimposing lens. Usually, sags are produced in boundary surfaces of the adjacent first small lenses of the first multi-lens array, and desired lens performance is not obtained in the peripheral portions of the respective first small lenses. Accordingly, it is considered that the light passing through the inner side than the peripheral portion of the first small lens is used as the illumination light and the light passing through the peripheral portion is not used as the illumination light. However, when the light in the peripheral portion of the first small lens is not used as the illumination light, there is a problem that light use efficiency of the illumination device becomes lower.

On the other hand, in the illumination device 2 of the embodiment, as described above, the second small lens 54 of the second multi-lens array 52 correspond to the four first small lenses 53 of the first multi-lens array 51, and thereby, the four partial pencils of light Wp illuminate the image formation areas 14R, 14G, 14B of the light modulators 4R, 4G, 4B.

Also, in the first multi-lens array 51 of the embodiment, sags at manufacturing are produced in the peripheral portions of the first small lenses 53. In the illumination device 2 of the embodiment, the partial pencils of light Wp by the respective first small lenses 53 of the first multi-lens array 51 are collected on the image formation areas 14R, 14G, 14B of the light modulators 4R, 4G, 4B, and thereby, the projection scaling factor from the single first small lens 53 of the first multi-lens array 51 on the image formation area 14R may be reduced.

Here, the projection scaling factor of the partial pencils of light Wp by the first small lens 53 is reduced, and thereby, an irregularity area in which illuminance irregularities are produced due to the sags in the peripheral portion of the first small lens 53 is also reduced. In the case of the embodiment, the image of the partial pencils of light Wp by the first small lens 53 are reduced to ¼ on the image formation area 14R and, compared to the configuration of the comparative example, a width of the frame-like illuminance irregularities produced in the peripheral portion of the image of the partial pencils of light Wp is also reduced to ¼. Accordingly, streaky illuminance irregularities produced between the four partial pencils of light Wp formed on the image formation areas 14R, 14G, 14B of the light modulators 4R, 4G, 4B may be made harder to be noticed.

Further, the inventor focused on further reduction of the streaky illuminance irregularities produced on the image formation areas by adjustment of the degrees of overlap of the peripheral portions of the images of the adjacent partial pencils of light on the image formation areas.

Specifically, in the illumination device 2 of the embodiment, the distance between the first multi-lens array 51 and the second multi-lens array 52 is adjusted by the adjustment mechanism 30, and thereby, the degrees of imaging of the partial pencils of light Wp on the image formation areas 14R, 14G, 14B by the respective second small lenses 54 of the second multi-lens array 52 are adjusted.

For example, the adjustment mechanism 30 moves the points of focus of the partial pencils of light Wp to the deeper sides than the image formation areas 14R, 14G, 14B by reducing the distance between the first multi-lens array 51 and the second multi-lens array 52, and moves the points of focus of the partial pencils of light Wp to the front sides of the image formation areas 14R, 14G, 14B by increasing the distance between the first multi-lens array 51 and the second multi-lens array 52.

In the above described manner, in the illumination device 2 of the embodiment, the collection positions of the partial pencils of light Wp by the respective second small lenses 54 are adjusted so that the partial pencils of light Wp may be defocused and entered onto the image formation areas 14R, 14G, 14B by the adjustment mechanism 30, and thereby, the degrees of overlap of the peripheral portions of the adjacent partial pencils of light Wp may be adjusted and the streaky illuminance irregularities produced on the image formation areas 14R, 14G, 14B may be reduced.

Further, the inventor focused on further reduction of the streaky illuminance irregularities produced on the image formation areas by adjustment of differences in the points of focus between the center portions and the peripheral portions of the partial pencils of light imaged on the image formation areas.

Specifically, in the illumination device 2 of the embodiment, the plurality of second small lenses 54 of the second multi-lens array 52 are formed using aspheric lenses, and thereby, the differences in the points of focus between the center portions and the peripheral portions of the partial pencils of light Wp on the image formation area 14R by the respective second small lenses 54 of the second multi-lens array 52 are reduced.

The second small lenses 54 of the aspheric lenses correct the differences in the points of focus of the partial pencils of light Wp due to field curvature aberration, and thereby, the illuminance irregularities produced within the illuminated surfaces of the partial pencils of light Wp are reduced.

In the above described manner, in the illumination device 2 of the embodiment, the second small lenses 54 are formed using the aspheric lenses, and thereby, the uniformity of the illuminance distributions of the respective partial pencils of light Wp may be increased and the streaky illuminance irregularities produced on the image formation areas 14R, 14G, 14B may be further reduced.

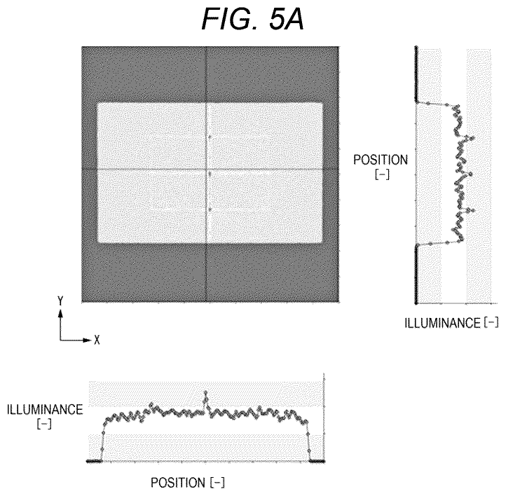

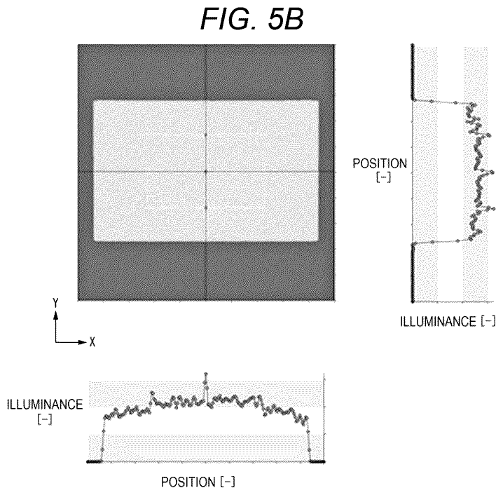

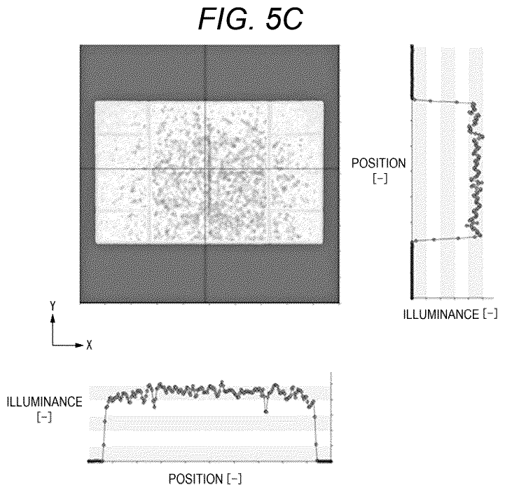

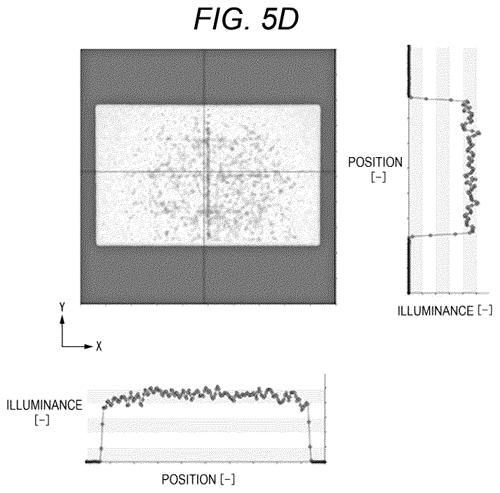

The inventor performed simulations for confirmation of the effects of the projector of the present disclosure. FIGS. 5A, 5B, 5C, 5D show simulation results by the inventor. In the simulations, a model in which the number of divisions of the first small lenses for the single second small lens of the second multi-lens array is increased to 16 more than that of the configuration of the above described embodiment is used. Further, in the simulations, as a defocus condition in the illuminated area, an amount of defocus is shifted by +0.05 mm, that is, the point of focus is shifted by 0.05 mm toward the depth side.

FIG. 5A shows a simulation result when the partial pencils of light are not defocused on the illuminated area and the second small lenses are spherical lenses, i.e., a simulation result of a combination of without defocus and spherical lenses.

FIG. 5B shows a simulation result when the partial pencils of light are not defocused on the illuminated area and the second small lenses are aspheric lenses, i.e., a simulation result of a combination of without defocus and aspheric lenses.

FIG. 5C shows a simulation result when the partial pencils of light are defocused on the illuminated area and the second small lenses are spherical lenses, i.e., a simulation result of a combination of with defocus and spherical lenses.

FIG. 5D shows a simulation result when the partial pencils of light are defocused on the illuminated area and the second small lenses are aspheric lenses, i.e., a simulation result of a combination of with defocus and aspheric lenses.

The graphs on the right of the respective drawings show illuminance distributions along the Y-axis directions and the graphs on the downside of the respective drawings show illuminance distributions along the X-axis directions.

As shown in FIGS. 5A and 5B, when the partial pencils of light divided by the plurality of first small lenses are reduced and imaged on the illuminated area, slight streaky illuminance irregularities are produced in a part in which the images of the four partial pencils of light are collected on the illuminated illumination area, but illuminance distributions without noticeable illuminance irregularities as a whole are obtained. Note that, when the partial pencils of light are not defocused, not a large difference appears in the illuminance distributions between the second small lenses as spherical lenses and aspheric lenses.

On the other hand, it was found that, as shown in FIGS. 5C, 5D, when the partial pencils of light divided by the plurality of first small lenses are reduced and defocused and entered onto the illuminated area, an illuminance distribution in which the streaky illuminance irregularities less noticeable is obtained in the case where the second small lenses are formed using the aspheric lenses than those in the case where the second small lenses are formed using the spherical lenses.

That is, when the partial pencils of light divided by the plurality of first small lenses are reduced and imaged on the illuminated area as in the projector of the present disclosure, by the combination of with defocus and aspheric lenses, the highly uniform illuminance distribution with the suppressed streaky illuminance irregularities produced between the adjacent partial pencils of light may be obtained on the illuminated area.

As described above, the projector 1 of the embodiment includes the light source 20, the collimator 26 parallelizing the illumination light WL output from the light source 20, the first multi-lens array 51 having the plurality of first small lenses 53 dividing the illumination light WL parallelized by the collimator 26 into the plurality of partial pencils of light Wp and the plurality of light incident regions 51R each containing at least the two first small lenses 53, the second multi-lens array 52 having the plurality of second small lenses 54 placed to correspond to the respective plurality of light incident regions 51R of the first multi-lens array 51, the superimposing lens 60 superimposing the plurality of partial pencils of light Wp output from the respective plurality of second small lenses 54 of the second multi-lens array 52 on the image formation areas 14R, 14G, 14B as illumination areas, and the light modulators 4R, 4G, 4B modulating the light entering the superimposing lens 60. The single second small lens 54 is entered by the partial pencils of light Wp from the respective at least two first small lenses 53 in the corresponding light incident region 51R.

According to the projector 1 of the embodiment, the image formation areas 14R, 14G, 14B of the light modulators 4R, 4G, 4B are illuminated by the four partial pencils of light Wp, and thereby, the projection scaling factors of the respective partial pencils of light Wp are reduced and the widths of the frame-shaped illuminance irregularities produced in the peripheral portions of the images of the partial pencils of light Wp may be reduced. Therefore, in the projector 1 of the embodiment, the streaky illuminance irregularities produced between the partial pencils of light Wp imaged on the image formation areas 14R, 14G, 14B of the light modulators 4R, 4G, 4B may be made harder to be noticed.

In the projector 1 of the embodiment, the respective plurality of second small lenses 54 are formed using the aspheric lenses.

Thereby, the illuminance irregularities produced within the radiation plane of the partial pencils of light Wp may be reduced by correction of differences in the points of focus of the partial pencils of light Wp due to field curvature aberration. Therefore, the uniformity of the illuminance distributions of the respective partial pencils of light Wp is increased, and thereby, the streaky illuminance irregularities produced on the image formation areas 14R, 14G, 14B may be further reduced.

Further, the projector 1 of the embodiment includes the adjustment mechanism 30 adjusting the distance between the first multi-lens array 51 and the second multi-lens array 52.

Thereby, the collection positions of the partial pencils of light Wp by the respective second small lens 54 may be adjusted to defocus and enter the partial pencils of light Wp onto the image formation areas 14R, 14G, 14B, and the streaky illuminance irregularities produced on the image formation areas 14R, 14G, 14B may be further reduced by adjustment of the degrees of overlap between the peripheral portions of the adjacent partial pencils of light Wp.

Therefore, according to the projector 1 of the embodiment, the projector with higher display quality and higher efficiency may be provided.

### Second Embodiment

Subsequently, a configuration of a projector of a second embodiment will be explained. The embodiment and the first embodiment are different in the configuration of the light source and provision of a polarization converter, and the other configurations are the same. Accordingly, the configurations common with the above described embodiment have the same signs and the explanation of the details will be omitted.

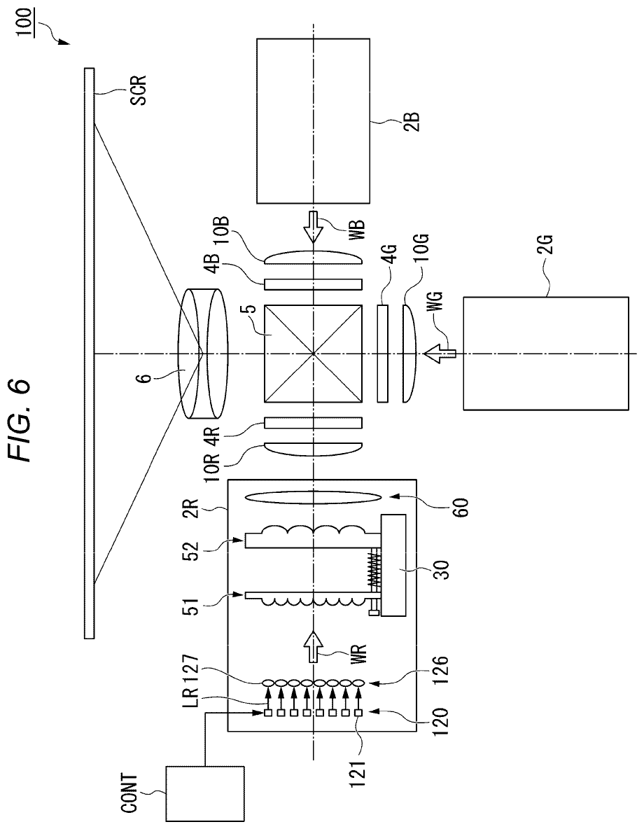

FIG. 6 is a schematic configuration diagram showing the projector of the second embodiment.

As shown in FIG. 6, a projector 100 of the embodiment includes a first illumination device 2R, a second illumination device 2G, a third illumination device 2B, the light modulator 4R, the light modulator 4G, the light modulator 4B, the light combining system 5, the projection optical device 6, and the field lenses 10R, 10G, 10B.

The first illumination device 2R outputs a red illumination light WR toward the light combining system 5, the second illumination device 2G outputs a green illumination light WG toward the light combining system 5, and the third illumination device 2B outputs a blue illumination light WB toward the light combining system 5. The first illumination device 2R, the second illumination device 2G, and the third illumination device 2B have equal basic configurations except output of illumination lights in different colors. As below, the configuration of the first illumination device 2R will be explained as an example.

The first illumination device 2R includes a light source 120, a collimator 126, the first multi-lens array 51, the second multi-lens array 52, the superimposing lens 60, the adjustment mechanism 30, and a controller CONT.

The light source 120 has a plurality of laser emitters (light emitters) 121 provided to correspond to each of the plurality of first small lenses 53 of the first multi-lens array 51 and outputting the red lights LR toward the corresponding first small lenses 53. Accordingly, the lights may be efficiently entered into the respective first small lenses 53.

The collimator 126 of the embodiment includes a collimator lens array. The collimator 126 includes a plurality of collimator lenses 127 arranged in an array form. The single collimator lens 127 is placed in a position entered by the red light LR output from the single laser emitter 121.

The collimator 126 parallelizes the red lights LR output from the plurality of laser emitters 121 and outputs a red illumination light R as a parallel luminous flux toward the first multi-lens array 51.

The controller CONT is an arithmetic processing unit such as a CPU (Central Processing Unit) or an FPGA (Field-Programmable Gate Array) and controls at least driving of the respective laser emitters 121 of the light source 120.

The controller CONT drives light emission intensity of a part of the light emitters of the plurality of laser emitters 121 to be different from light emission intensity of another part of the laser emitters 121. Specifically, the controller CONT controls driving of the respective laser emitters 121 to increase the light emission intensity of the laser emitters 121 corresponding to the first small lenses 53 generating the partial pencils of light of the area for displaying a bright image in the image formation area 14R of the light modulator 4R and decrease the light emission intensity of the laser emitters 121 corresponding to the first small lenses 53 generating the partial pencils of light of the area for displaying a dark image in the image formation area 14R.

According to the configuration, the partial pencils of light in the required amounts are entered into each area of the image display area, and thereby, the bright image may be displayed to be brighter and the dark image may be displayed to be darker and the contrast ratio of the image may be increased. Further, the light modulators 4R, 4G, 4B do not cut the lights entered from the light source 120 by modulation, and thereby, the respective illumination lights WR, WG, WB output from the light source 120 may be efficiently used for generation of image lights in the light modulators 4R, 4G, 4B.

Therefore, according to the projector 100 of the embodiment, the high-efficiency projector displaying the image with the higher contrast ratio may be provided.

In the projector 100 of the second embodiment, the case where the laser emitters 121 are used as the light emitters of the light sources 120 of the respective illumination devices 2R, 2G, 2B is taken as an example, however, in place of the laser emitters, light emitting diodes (LEDs) or fluorescence emitters emitting fluorescence may be used. When the light emitting diodes or the fluorescence emitters are used, the illumination lights emitted from the respective illumination devices 2R, 2G, 2B are unpolarized lights different from the laser beams. Accordingly, it is necessary to align the polarization directions of the illumination lights emitted from the respective illumination devices 2R, 2G, 2B with transmission axes of the light modulators 4R, 4G, 4B in advance.

### Modified Example

As below, as a modified example, a configuration of emitting an unpolarized illumination light WR from the light source 120 of the first illumination device 2R in the projector 100 of the second embodiment will be explained.

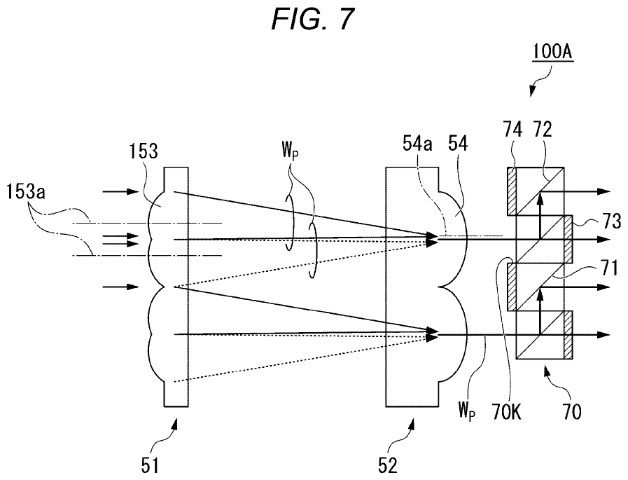

FIG. 7 shows a configuration of a main part of a projector of the modified example. FIG. 7 shows a peripheral configuration of the first multi-lens array 51 and the second multi-lens array 52 as characteristic parts of the modified example. Further, FIG. 7 shows a configuration of the first illumination device 2R.

As shown in FIG. 7, the first illumination device 2R of a projector 100A of the modified example includes a polarization converter 70 placed between the second multi-lens array 52 and the superimposing lens 60. The polarization converter 70 aligns the polarization directions of the lights output from the second multi-lens array 52 with directions of transmission axes of the light incident-side polarizers of the light modulators 4R, 4G, 4B. Thereby, the lights transmitted through the polarization converter 70 are respectively not shielded by the light incident-side polarizers, but respectively enter the image formation areas of the light modulators 4R, 4G, 4B.

The polarization converter 70 has a plurality of polarization separation layers 71, a plurality of reflection layers 72, a plurality of retardation layers 73, and a light shielding film 74. The retardation layers 73 are provided at a light exiting side of the polarization converter 70. The polarization converter 70 includes a plurality of incident openings 70K through which the plurality of partial pencils of light Wp output from the second small lenses 54 of the second multi-lens array 52 pass. Each incident opening 70K is formed by an opening formed in the light shielding film 74 placed at the light incident side in the polarization converter 70.

The respective incident openings 70K are placed to correspond to the respective second small lenses 54 of the second multi-lens array 52, and the sizes of the respective incident openings 70K are smaller than the outer shapes of the second small lenses 54. Accordingly, part of the light transmitted through the peripheral portion of the second small lens 54 may not pass through the incident opening 70K of the polarization converter 70, but be shielded to be a loss.

On the other hand, in the projector 100A of the modified example, respective first small lenses 153 of the first multi-lens array 51 are eccentrically provided so that the partial pencils of light Wp output from each of the first small lenses 153 enter the single incident opening 70K of the polarization converter 70 via the corresponding second small lens 54.

Specifically, an optical axis 153a of each first small lens 153 is eccentric in a direction away from the center axis of the light incident region 51R. That is, the eccentricity direction of the optical axis 153a is set in a direction in which the partial pencils of light Wp output from the first small lens 153 are closer to an optical axis 54a of the corresponding second small lens 54.

According to the projector 100A of the modified example, the first small lens 153 is formed using an eccentric lens and the partial pencils of light Wp divided by each first small lens 153 may be collected to be closer to the optical axis 54a of the second small lens 54. Accordingly, the plurality of partial pencils of light Wp entering from the respective first small lenses 153 are collected to the optical axes 54a as the center parts of the second small lenses 54 and may preferably enter the respective incident openings 70K of the polarization converter 70 placed downstream of the second small lenses 54. Accordingly, the polarization converter 70 may efficiently take in the partial pencils of light Wp divided by the respective first small lenses 153 of the first multi-lens array 51 through the second small lenses 54.

Therefore, according to the projector 100A of the modified example, in the case where unpolarized illumination lights are output from the respective illumination devices 2R, 2G, 2B, the polarization directions of the partial pencils of light Wp divided by the plurality of first small lenses 153 of the first multi-lens array 51 may be aligned by the polarization converter 70. Thus, in the projector 100A of the modified example, the unpolarized illumination lights output from the respective illumination devices 2R, 2G, 2B may be efficiently taken in the image formation areas of the light modulators 4R, 4G, 4B, and the high-efficiency projector displaying brighter images with higher quality may be provided.

Note that the technical scope of the present disclosure is not limited to the above described embodiments, but various changes can be made without departing from the scope of the present disclosure.

The specific description of the shapes, the numbers, the placements, the materials, etc. of the respective component elements of the projector shown in the above described embodiments are not limited to those of the above described embodiments, but can be appropriately changed.

For example, in the above described embodiments, the case where the aspect ratio of the light incident region 51R of the first multi-lens array 51 and the aspect ratios of the respective first small lens 53 in the light incident region 51R are respectively equal to the aspect ratios of the image formation areas 14R, 14G, 14B of the light modulators 4R, 4G, 4B is taken as an example, however, the present disclosure is not limited to that.

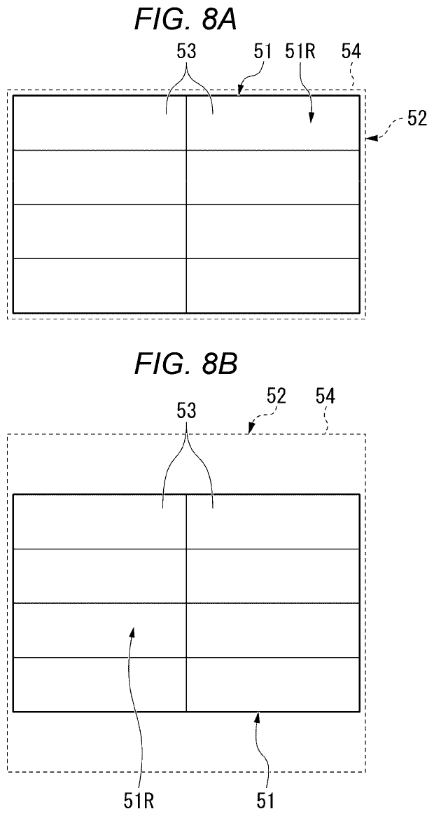

FIGS. 8A and 8B show examples of different correspondence relationships between the first small lenses and the second small lens.

As shown in FIG. 8A, the aspect ratio of the light incident region 51R may be equal to the aspect ratios of the respective image formation areas 14R, 14G, 14B of the light modulators 4R, 4G, 4B and the aspect ratios of the respective first small lenses 53 in the light incident region 51R may be different from the aspect ratios of the respective image formation areas 14R, 14G, 14B of the light modulators 4R, 4G, 4B.

According to the configuration, the aspect ratio of the first small lens 53 may be set to the aspect ratios of the image formation areas 14R, 14G, 14B and a desired value, and thereby, the degrees of freedom of design including the shape and the division number of the first small lenses 53 may be increased.

Further, in the above described embodiments, the case where, in the light incident region 51R and the second small lens 54 corresponding to each other, the planar shapes of the second small lens 54 and the light incident region 51R are the same shape is taken as an example, however, the present disclosure is not limited to that.

As shown in FIG. 8B, in the light incident region 51R and the second small lens 54 corresponding to each other, the planar shape of the second small lens 54 may be larger than the planar shape of the light incident region 51R. In this case, the light incident regions 51R of the first multi-lens array 51 and the second small lenses 54 of the second multi-lens array 52 are easily aligned.

In the case of the modified example, the second small lens 54 is larger than the light incident region 51R in size and there is a region where the light from the first multi-lens array 51 does not enter in a part of the second small lens 54.

Accordingly, the form shown in FIG. 8B can be realized in a case where the light source 120 having the plurality of laser emitters 121 corresponding to the respective first small lenses 53 of the first multi-lens array 51 is combined like the projector 100A of the second embodiment.

As below, the summary of the present disclosure is appended.

### Appendix 1

A projector includes a light source, a collimator parallelizing a first light output from the light source, a first multi-lens array having a plurality of first small lenses dividing the first light parallelized by the collimator into a plurality of partial pencils of light and a plurality of light incident regions each containing at least two of the first small lenses, a second multi-lens array having a plurality of second small lenses placed to correspond to the respective plurality of light incident regions of the first multi-lens array, a superimposing lens superimposing the plurality of partial pencils of light output from the respective plurality of second small lenses of the second multi-lens array on an illumination area, and a light modulator containing an image formation area as the illumination area and modulating a light output from the superimposing lens, wherein the partial pencils of light output from the respective at least two first small lenses contained in the corresponding single light incident region enter the single second small lens.

According to the projector having the configuration, projection scaling factors of the respective partial pencils of light are reduced by illumination of the image formation area of the light modulator by the plurality of partial pencils of light, and widths of frame-shaped illuminance irregularities produced in peripheral portions of the images of the partial pencils of light may be reduced. Therefore, in the projector having the configuration, the streaky illuminance irregularities produced between the partial pencils of light imaged on the image formation area of the light modulator may be made harder to be noticed. Thus, the high-efficiency projector with higher display quality may be provided.

### Appendix 2

In the projector according to Appendix 1, the respective plurality of second small lenses are formed using aspheric lenses.

According to the configuration, the illuminance irregularities produced within a radiation plane of the partial pencils of light may be reduced by correction of differences in the points of focus of the partial pencils of light due to field curvature aberration. Therefore, uniformity of the illuminance distributions of the respective partial pencils of light is increased, and thereby, the streaky illuminance irregularities produced on the image formation area may be further reduced.

### Appendix 3

In the projector according to Appendix 1 or Appendix 2, the light source has a plurality of light emitters provided to correspond to the respective plurality of first small lenses of the first multi-lens array and outputting lights toward the corresponding first small lenses.

According to the configuration, the lights may be efficiently entered into the respective first small lenses.

### Appendix 4

The projector according to Appendix 3 further includes a polarization converter placed between the second multi-lens array and the superimposing lens and converting a polarization direction of a light output from the second multi-lens array, wherein the polarization converter has a plurality of incident openings entered by the lights output from the respective plurality of second small lenses of the second multi-lens array, and at least the two first small lenses in the single light incident region of the first multi-lens array are respectively eccentrically provided to enter the partial pencils of light output from the respective first small lenses into the single incident opening of the polarization converter via the corresponding single second small lens.

According to the configuration, in a case where an unpolarized light is output from the light source, the polarization directions of the partial pencils of light divided by the plurality of first small lenses of the first multi-lens array may be aligned by the polarization converter. Thus, the unpolarized light may be efficiently taken in the image formation area of the light modulator, and the high-efficiency projector displaying brighter images with higher quality may be provided.

### Appendix 5

The projector according to Appendix 3 or Appendix 4 further includes a controller controlling driving of the plurality of light emitters, wherein the controller drives the plurality of light emitters to make light emission intensity of a part of the light emitters different from light emission intensity of another part of the light emitters.

According to the configuration, the partial pencils of light in the required amounts are entered into each area of the image display area, and thereby, the bright image may be displayed to be brighter and the dark image may be displayed to be darker and the contrast ratio of the image may be increased. Further, it is not necessary for the light modulator to cut the light entering from the light source by modulation, and the light output from the light source may be efficiently used for generation of an image light.

### Appendix 6

The projector according to any one of Appendix 1 to Appendix 5, in the light incident region and the second small lens corresponding to each other, a planar shape of the second small lens is larger than a planar shape of the light incident region.

According to the configuration, the light incident regions of the first multi-lens array and the second small lenses of the second multi-lens array are easily aligned.

### Appendix 7

The projector according to any one of Appendix 1 to Appendix 6, an aspect ratio of the light incident region, aspect ratios of the respective first small lenses in the light incident region, and an aspect ratio of the image formation area of the light modulator are respectively equal.

According to the configuration, the aspect ratio of the first multi-lens array is set to be equal to the aspect ratio of the light modulator, and the manufacture of the first multi-lens array is easier.

### Appendix 8

The projector according to any one of Appendix 1 to Appendix 7, aspect ratios of the respective first small lenses in the light incident region are different from an aspect ratio of the image formation area of the light modulator, and an aspect ratio of the light incident region is equal to the aspect ratio of the image formation area of the light modulator.

According to the configuration, the collection positions of the partial pencils of light by the respective second small lenses may be adjusted to defocus and enter the partial pencils of light on the image formation area, and the streaky illuminance irregularities produced on the image formation area may be further reduced by adjustment of degrees of overlap of the peripheral portions of the adjacent partial pencils of light.

### Appendix 9

The projector according to any one of Appendix 1 to Appendix 8 further includes an adjustment mechanism configured to adjust a distance between the first multi-lens array and the second multi-lens array.

According to the projector having the configuration, the high-efficiency projector with higher display quality may be provided.

What is claimed is:

1. A projector comprising:
a light source;
a collimator configured to collimate a first light emitted from the light source;
a first multi-lens array having a plurality of first small lenses configured to divide the first light collimated by the collimator into a plurality of partial pencils of light, and a plurality of light incident regions each containing at least two of the first small lenses;
a second multi-lens array having a plurality of second small lenses placed to correspond to the respective plurality of light incident regions of the first multi-lens array;
a superimposing lens configured to superimpose the plurality of partial pencils of light emitted from the respective plurality of second small lenses of the second multi-lens array on an illumination area; and
a light modulator containing an image formation area as the illumination area and configured to modulate light emitted from the superimposing lens, wherein
the partial pencils of light emitted from the respective at least two first small lenses contained in the corresponding single light incident region enter the single second small lens.

2. The projector according to claim 1, wherein
the respective plurality of second small lenses are aspheric lenses.

3. The projector according to claim 1, wherein
the light source has a plurality of light emitters disposed to correspond to the respective plurality of first small lenses of the first multi-lens array and configured to emit lights toward the corresponding first small lenses.

4. The projector according to claim 3 further comprising
a polarization converter disposed between the second multi-lens array and the superimposing lens and configured to convert a polarization direction of a light emitted from the second multi-lens array, wherein
the polarization converter has a plurality of incident openings entered by the lights output from the respective plurality of second small lenses of the second multi-lens array, and
at least the two first small lenses in the single light incident region of the first multi-lens array are respectively eccentrically provided to enter the partial pencils of light emitted from the respective first small lenses into the single incident opening of the polarization converter via the corresponding single second small lens.

5. The projector according to claim 3 further comprising
a controller configured to control driving of the plurality of light emitters, wherein
the controller drives the plurality of light emitters to make light emission intensity of a part of the light emitters different from light emission intensity of another part of the light emitters.

6. The projector according to claim 1, wherein
in the light incident region and the second small lens corresponding to each other, a planar shape of the second small lens is larger than a planar shape of the light incident region.

7. The projector according to claim 1, wherein
a first aspect ratio of the light incident region, second aspect ratios of the respective first small lenses in the light incident region, and a third aspect ratio of the image formation area of the light modulator are respectively equal.

8. The projector according to claim 1, wherein
first aspect ratios of the respective first small lenses in the light incident region are different from a second aspect ratio of the image formation area of the light modulator, and
a third aspect ratio of the light incident region is equal to the second aspect ratio of the image formation area of the light modulator.

9. The projector according to claim 1 further comprising
an adjustment mechanism configured to adjust a distance between the first multi-lens array and the second multi-lens array.
